(19) United States
(12) Patent Application Publication
(10) Pub. No.: US 2010/0215563 A1
(43) Pub. Date: Aug. 26, 2010

(54) METHOD FOR PRODUCING SILICON

(76) Inventor: Toshiharu Yambayashi, Ibaraki (JP)

Correspondence Address: BIRCH STEWART KOLASCH & BIRCH, PO BOX 747, FALLS CHURCH, VA, 22040-0747, US

(21) Appl. No.: 12/675,670

(22) PCT Filed: Aug. 28, 2008
(86) PCT No.: PCT/JP2008/065923

§ 371 Date: May 3, 2010

(30) Foreign Application Priority Data
Aug. 29, 2007 (JP) 2007-223030

(51) Int. Cl. C01B 33/021

(52) U.S. Cl. 423/350

(57) ABSTRACT

The invention provides a method for producing silicon. The method for producing silicon is a method wherein a halogenated silane represented by the following formula (1) is reduced with a metal, the method comprising a first step of bringing metal particles into contact with a halogenated silane at a temperature T1 below the melting point of the metal to obtain silicon, and a second step following the first step, of bringing the metal residue into contact with a halogenated silane at a temperature T2 at or above the melting point of the metal to obtain additional silicon.

SiHₙX₄₋ₙ (1)

In the formula, n represents an integer of 0-3 and X represents an atom selected from the group consisting of F, Cl, Br and I. When n is 0-2, X may be the same or different.

### TECHNICAL FIELD

The present invention relates to a method for producing silicon. In particular, the invention relates to a method for producing silicon which is suitable for manufacture of solar cells.

### BACKGROUND ART

The Siemens method, involving reaction of trichlorosilane and hydrogen at high temperature, is the main method employed for producing semiconductor grade silicon. The method yields extremely high purity silicon, but its high cost has limited efforts to further reduce cost.

With increasing focus on environmental problems, solar cells are becoming popular as clean energy sources and demand for their home use is drastically increasing. Because silicon-based solar cells have excellent reliability and conversion efficiency, they currently occupy about 80% of the solar photovoltaic power generation market. Silicon for solar cells is obtained mainly from off-grade semiconductor grade silicon as starting materials. It is desirable to ensure low-cost silicon sources to further reduce electric power generation costs.

Alternative methods to the Siemens method include methods using metals such as zinc or aluminum for reduction of chlorosilane. Methods of reduction using aluminum including methods of contacting fine particulate aluminum with silicon tetrachloride gas to obtain silicon (for example, Japanese Unexamined Patent Publication SHO No. 59-182221). They also include methods of contacting a gaseous silicon compound having the formula SiHₙX₄₋ₙ (where X represents a halogen atom and n represents an integer of 0-3) with the melting surface of finely dispersed pure aluminum or Al—Si alloy (for example, Japanese Unexamined Patent Publication HEI No. 2-64006).

### DISCLOSURE OF THE INVENTION

A finely dispersed metal can increase the reactivity compared to a bulky solid metal. When the reaction temperature is above the melting point of the metal, however, the metallic particles may fuse creating coarse particles if the molten metal is atomized in the reactor, for example. It is therefore difficult to accomplish effective contact between the metal and gas, and the silicon content, or the metal conversion, does not sufficiently increase within a brief period of time. On the other hand, the reaction rate is slow when the dispersed metal is reacted with the gas at below the melting point of the metal, and therefore more time is necessary to achieve the prescribed conversion and economy is sacrificed. Furthermore, since the reaction rate is lower with increased silicon deposited on the surface, it becomes impossible to achieve a satisfactory conversion.

In methods of reacting directly blown gas with a molten metal, when the metal is aluminum, for example, a high-temperature process at 1200° C. or above is necessary to obtain a high conversion because solid phase deposition begins, reducing the liquid phase portion, at the point of intersection between the reaction temperature and liquid phase curve in the aluminum-silicon binary alloy phase diagram. With reaction at high temperature, however, the yield is reduced due to production of silicon or metal subhalides.

In order to solve the problems described above, the invention provides a method for efficiently producing silicon, and particularly a method for efficiently producing silicon that is suitable for manufacture of solar cells. Specifically, it provides a method for producing silicon wherein a high conversion is exhibited in reduction of a halogenated silane with a metal.

The invention is a method for producing silicon wherein a halogenated silane represented by the following formula (1) is reduced with a metal, the method comprising a first step of bringing metal particles into contact with a halogenated silane at a temperature T1 below the melting point of the metal to obtain silicon, and a second step following the first step, of bringing the metal residue into contacted with a halogenated silane at a temperature T2 at or above the melting point of the metal to obtain additional silicon.

SiHₙX₄₋ₙ (1)

[In the formula, n represents an integer of 0-3 and X represents an atom selected from the group consisting of F, Cl, Br and I. When n is 0-2, X may be the same or different.]

In the first step, the metal is contacted with a gaseous halogenated silane represented by the above formula (1) for halogenation, whereby the halogenated silane is reduced and silicon is deposited on the surface of the metal remaining as the unreacted substance. The produced metal halide is removed from the system as a gas, thus lowering the metal mass.

In the subsequent second step, the remaining metal is heated to temperature T2 which is equal to or more than the melting point of the metal. However, since the precipitated silicon is present on the surface of the remaining metal in the first step, fusion between the metallic particles and coarsening of the particles are interfered even if heated at temperature T2. When the temperature rises sufficiently above that in the first step, the halogenated silane diffusion rate and the reaction rate between the halogenated silane gas and metal increase, thus increasing the metal conversion. As a result, it is easier to obtain even more silicon than after the first step.

The proportion of the silicon mass with respect to the total mass of the metal residue and the obtained silicon is preferably 5 mass % or greater and less than 85 mass % upon completion of the first step.

If the proportion of the silicon mass with respect to the total mass of the metal residue and the obtained silicon after reaction at temperature T1 is significantly lower than 5 mass %, fewer silicon fine particles will be present on the metal surface during the reaction at temperature T2, causing the metallic particles to fuse more easily and thus producing coarser metallic particles, which will impede progress of the reaction. If it is significantly greater than 85 mass %, on the other hand, a relatively longer reaction time will be necessary in the first step, thus tending to impair the halogenated silane reaction efficiency and reduce economy. A range of 5 mass % or greater and less than 85 mass % will allow efficient production of silicon of sufficiently practical purity in the second step.

The first step and second step are preferably carried out in a fixed bed reactor. The reaction whereby the halogenated silane is reduced by the metal to produce silicon and a metal halide is an exothermic reaction. The heat of reaction can be efficiently utilized because the metallic particles contact each other in the fixed bed reactor.

The first step and second step may also be suitably carried out in a rotary kiln or a fluidized bed reactor. This will increase the solid/gas contact efficiency while also forming a temperature gradient in the furnace so that the metallic particles can be transported from the temperature T1 section to the temperature T2 section, for continuous reduction reaction.

The metal preferably includes one or more metals selected from the group consisting of potassium, cesium, rubidium, strontium, lithium, sodium, magnesium, aluminum, zinc and manganese.

The metal is most preferably aluminum. This will facilitate removal of the metal by acid or alkali dissolution or segregation, even when the metal is remaining in or on the surface of the produced silicon. Corrosion of the structural members of the reactor will also be prevented.

The halogenated silane preferably includes one or more selected from among silicon tetrachloride, trichlorosilane, dichlorosilane and monochlorosilane.

Preferably, the boron and phosphorus contents of the halogenated silane are each less than 1 ppm, and the boron and phosphorus contents in the metal silicon are each less than 1 ppm. This will allow high purity silicon to be more easily obtained.

Incidentally, finely dispersed metallic particles are hygroscopic and moisture (including that which is present in the form of hydroxyl groups or adsorbed as compounds with the metal) is adsorbed onto the particle surfaces. Since the moisture reacts with the metal at high temperature to form an oxide film, it not only interferes with the reducing power of the chlorosilane, but if it remains in the silicon it impairs the purity of the silicon and can lower the solar cell properties, for example. The moisture can be removed by performing vacuum drying of the metallic particles before the first step, but this introduces problems such as increased time required for dewatering and increased production cost due to the expanded equipment necessary for handling of the metallic particles in the dried atmosphere after the dehydration step and before the first step.

According to the invention, the temperature T1 in the first step is preferably a temperature which is at least 0.6 times the melting point [° C.] of the metal, and below the melting point of the metal. This can reduce the oxygen concentration of the metallic particles during the first step before the second step, and increase the reduction conversion while improving the purity of the product.

Specifically, while the detailed reaction mechanism is unclear, the present inventors have found that reaction between the halogenated silane and metal at the prescribed temperature causes the halogenated silane to also react with the moisture adsorbed on the metal surface to produce siloxane or silica, thus resulting in removal of moisture from the metallic particle surfaces in the halogenated silane gas stream. Removal of moisture is insufficient at below 0.6 times the melting point [° C.] of the metal, and the metal oxide film thickens during reduction, tending to lower the conversion. At above the melting point [° C.] of the metal, a metal oxide film is immediately formed, thus also tending to lower the conversion. The metal and halogenated silane are preferably contacted in the first step in such a manner that the oxygen content of the metallic particles is less than 0.1 mass % upon completion of the first step. If the oxygen content is 0.1 mass % or greater, reduction of the metallic particles will not proceed sufficiently in the second step and the final conversion will tend to be reduced. An oxygen content of less than 0.1 mass %, on the other hand, will allow satisfactory reduction in the second step and particularly efficient production of silicon of sufficiently practical purity.

Incidentally, for removal of moisture on the metallic particle surfaces it is preferred for the temperature T1 in the first step to be a slightly lower temperature than the melting point of the metal, such as between 0.60 and 0.85 times the melting point [° C.] of the metal, but for adequate deposition of silicon on the metallic particle surfaces it is preferred for the temperature T1 in the first step to be near the melting point of the metal, such as at least 0.7 times and below 1 times the melting point [° C.] of the metal.

It is preferred, in the first step, to bring the metal particles into contact with halogenated silane at temperature T1a which is at least 0.6 times the melting point of the metal and below the melting point, and thereafter to further bring the metal particles into contact with the halogenated silane at temperature T1b which is above temperature T1a and below the melting point of the metal afterwards.

This will efficiently lower the oxygen concentration on the metallic particle surfaces during the contact treatment at temperature T1a which is lower than temperature T1b, while efficiently depositing silicon on the metal surfaces during the contact treatment at T1b which is higher than that temperature.

Temperature T2 in the second step is preferably at least 1.2 times the melting point [° C.] of the metal and below 0.8 times the melting point of silicon.

This will result in a high conversion and high yield while inhibiting generation of silicon or metal subhalides.

### BEST MODE FOR CARRYING OUT THE INVENTION

The method for producing silicon according to the invention is a method in which metal particles are contacted with a gaseous halogenated silane of the following formula (1) to reduce silicon.

SiHₙX₄₋ₙ (1)

[In the formula, n represents an integer of 0-3 and X represents an atom selected from the group consisting of F, Cl, Br and I. When n is 0-2, X may be the same or different.]

Specifically, contact between the metal and the gaseous halogenated silane results in halogenation of the metal and reduction of the halogenated silane, causing deposition of silicon. The produced metal halide is removed from the system as a gas, thus lowering the metal volume.

More specifically, first a first step is carried out in which the metal particles and the halogenated silane are contacted at temperature T1 below the melting point of the metal to obtain silicon, and then a second step is carried out, after the first step, in which the remaining metal is contacted with the halogenated silane at temperature T2 at or above the melting point of the metal to produce additional silicon.

In the first step, the temperature T1 of the reduction reaction is below the melting point of the metal. In terms of Celsius, the temperature T1 is preferably at least 0.6 times the melting point of the metal and below 1 times the melting point of the metal, more preferably at least 0.7 times the melting point of the metal and below 1 times the melting point of the metal, and even more preferably at least 0.8 times the melting point of the metal and below 0.95 times the melting point of the metal, although this will depend on the dispersed state of the metallic particles.

If temperature T1 is at least 0.6 times the melting point of the metal, the reaction rate between the metal and halogenated silane will be sufficiently high. Moisture adhering to the metal surface will also be removed by the reaction, thus reducing the amount of metal oxides produced in subsequent steps. The conversion between the metal and halogenated silane is therefore greater in the second step and the purity of the obtained silicon tends to be higher.

If temperature T1 is equal to or greater than 1 times the melting point, i.e. the melting point of the metal, the metallic particle surfaces will melt and fuse together, resulting in coarser metallic particles. Metal oxides are also very easily generated by the moisture adhering to the metal. As a result, the surface area of the metal portions of the particles is reduced and contact efficiency with the halogenated silane is notably reduced, such that the reaction virtually fails to proceed.

Therefore, for efficient removal of moisture on the metallic particle surfaces it is preferred for the temperature T1 in the first step to be a somewhat lower temperature than the melting point of the metal, such as a temperature of between 0.60 and 0.85 times the melting point of the metal, while for adequate deposition of silicon on the metallic particle surfaces it is preferred for the temperature T1 in the first step to be near, such as at least 0.7 times and below 1 times, the melting point of the metal.

Thus, it is preferable, in the first step, that the metal particles and halogenated silane are contacted at temperature T1a which is at least 0.6 times the melting point of the metal and below the melting point, and then the metal particles and the halogenated silane are contacted at temperature T1b which is above temperature T1a and below the melting point of the metal. Needless to mention, the temperature may be adjusted in 3 stages instead of 2 stages within the temperature range below the melting point of the metal.

This will efficiently lower the oxygen concentration on the metallic particles during the contact treatment at temperature T1a which is lower than temperature T1b, while efficiently depositing silicon on the metal surfaces during the contact treatment at T1b which is higher than that temperature.

The first step is preferably carried out to an extent such that the silicon content upon completion of the first step is 5 mass % or greater and less than 85 mass %, more preferably 20 mass % or greater and less than 80 mass % and even more preferably 30 mass % or greater and less than 70 mass %. The silicon content referred to here is the proportion of the silicon weight with respect to the total weight of the metal residue and the obtained silicon. The silicon itself that is obtained by reduction will often be adhering to the surface of the residual metal, but it will sometimes ablate from the surface of the metal. The obtained silicon includes all of these substances.

With a silicon content of less than 5 mass %, the silicon deposited on the metal surface will tend to be inadequate to prevent fusion between the metallic particles. The metallic particles will thus fuse during the reaction at temperature T2 in the second step, becoming coarser and impeding the reaction. Since a prolonged reaction will thus be necessary in the first step in order to obtain a silicon content of 85 mass % or greater, while the halogenated silane conversion will be poor and the economy reduced.

The first step is preferably carried out in such a manner that the oxygen content of the metallic particles is less than 0.1 mass % upon completion of the first step. This will inhibit formation of oxides especially in the second step and increase the reduction conversion in the second step, while also improving the purity.

In the first step at temperature T1, a silicon film composed of numerous silicon fine particles is formed on the surface of the remaining unreacted metal.

In the subsequent second step, temperature T2 for the reduction reaction is at or above the melting point of the metal. In terms of Celsius, the temperature T2 is preferably at or above the melting point of the metal and below the melting point of silicon, more preferably at or above 1.2 times the melting point of the metal and below 0.8 times the melting point of silicon, and even more preferably at or above 1.3 times the melting point of the metal and below 0.7 times the melting point of silicon, although this will depend on the dispersed state of the metallic particles. If temperature T2 is below the melting point of the metal, the reaction rate will be too slow. On the other hand, temperature T2 is preferably not equal to or above the melting point of silicon because the reduced silicon will melt and fuse with the unreacted metal, thereby lowering the conversion, while the silicon yield will be reduced due to generation of silicon or metal subhalides.

As the metal reacts in the first step, metal halides are released from the particles as gas, for example, resulting in lower mass and surface area of the metal. Deposition of the reduced silicon on the metal surface further reduces the contact area between the metal and gas. Thus, the reaction rate gradually slows as silicon is deposited in the first step. According to the invention, the process shifts to the second step at higher temperature in the stage in which the metallic particle reduction reaction rate has slowed, thereby allowing more efficient reaction of the metal to produce silicon. Moreover, since the second step is carried out after the silicon film has been formed on the metal surface, it is possible to sufficiently prevent fusion between the metallic particles and consequent reduction in the metal conversion, during reaction at temperature T2 which is equal to or above the melting point of the metal. In addition, if the temperature in the first step is within the prescribed range to remove moisture which is associated with oxidation of the metal from the metallic particle surfaces, it is possible to prevent formation of metal oxides on the particle surfaces in the second step, and thus further minimize reduction in the conversion by metal oxides and further improve the conversion.

The metal supplied to the first step is in the form of particles. The mean particle size is preferably 3 μm or greater and less than 1000 μm, more preferably 5 μm or greater and less than 400 μm, even more preferably 10 μm or greater and less than 200 μm and most preferably 15 μm or greater and less than 80 μm. If the mean particle size is larger than 1000 μm, the reaction will tend to stop at the metallic particle surfaces without proceeding into the interiors, and the conversion will thus be lowered. If the mean particle size is smaller than 3 μm the particles will tend to aggregate and the conversion will thus be lowered.

The material of the metallic particles used for the invention is preferably a metal with a lower melting point than silicon, and is preferably one or a mixture of two or more selected from the group consisting of potassium, cesium, rubidium, strontium, lithium, sodium, magnesium, aluminum, zinc and manganese. Aluminum is particularly preferred. Using aluminum will facilitate removal of the metal by acid or alkali dissolution or segregation, even when the metal is remaining in or on the surface of the produced silicon. Corrosion of the structural members of the reactor will also be inhibited.

Since a high metal purity will result in higher purity of the produced silicon, the metal used preferably has boron and phosphorus contents of both less than 1 ppm and a high purity of 99.98% or greater.

The method for producing the metallic particles may be, for example, an atomizing method, a pulverizing method or a method using plasma. The metallic particles used in the reduction reaction may be prepared beforehand, but alternatively a combination reactor in which both the first step and second step can be conducted may be constructed together with the apparatus used to prepare the metallic particles. In such cases, an atomizing method in which shear force is applied to the molten metal by contact with a rapid cooling gas to produce fine particles is especially preferred for higher productivity of the metallic particles. Directly supplying the obtained metallic particles to the reactor will eliminate the possibility of contact with air, thereby allowing the metallic particles to be produced without oxidation effects. As a result, silicon particles can be obtained with a high conversion.

As halogenated silanes there are preferred chlorosilanes such as silicon tetrachloride, trichlorosilane, dichlorosilane and monochlorosilane, but trichlorosilane, dichlorosilane and monochlorosilane which contain hydrogen generate hydrogen chloride by the reaction and can thus corrode the reactor materials and conduits. It is therefore most preferred to use silicon tetrachloride alone.

The halogenated silane purity is preferably such that the boron and phosphorus contents are each less than 1 ppm, for a purity of 99.99% or greater. The amount of halogenated silane is preferably in excess of the stoichiometric ratio based on the amount of metal.

The halogenated silane may be used alone for reduction, or it may be used as a mixed gas of the halogenated silane and an inert gas. When a mixed gas is used, the gas concentration of the halogenated silane in the mixed gas is preferably 10 vol % or greater. The inert gas is preferably nitrogen gas, argon gas, helium gas or neon gas, for example, and it is most preferably argon gas from the viewpoint of low reactivity between the halogenated silane and metal and ready availability.

The reduction reaction will normally be carried out in a reactor made of a material that is heat resistant for the reaction temperature and that does not contaminate the silicon. As examples of reactor materials there may be mentioned carbon, silicon carbide, silicon nitride, aluminum nitride, alumina, quartz and the like.

Since the main reduction reaction is an exothermic reaction, the heat of reaction can be utilized to increase the overall reaction temperature. Thus, when the first step and second step are carried out in a fixed bed reactor in which the reaction proceeds with the metallic particles in mutual contact, the conversion is improved compared to reaction when they are not in mutual contact.

A rotary kiln or a fluidized bed reactor may be used as the reactor. When a rotary kiln is used, the metallic particles are loaded into an inclined cylindrical furnace and the cylindrical furnace is rotated while introducing the halogenated silane gas, for reduction reaction. Because the furnace has an inclined structure, the metallic particle loading section is at temperature T1 which is below the melting point of the metal and the metallic particles are tumbled while being moved into the downstream section at temperature T2 which is equal to or above the melting point of the metal. As a result, silicon particles can be obtained with high efficiency.

When a fluidized bed reactor is used, pressurized halogenated silane gas is blown in from below toward the top to fluidize the metallic particles, and the temperature is increased from temperature T1 which is below the melting point of the metal to temperature T2 which is equal to or above the melting point of the metal, for reduction reaction. The reduction reaction can be carried out by forming a temperature gradient in the furnace and moving the metallic particles from an area at temperature T1 to temperature T2, similar to using a rotary kiln, or two or more furnaces kept at temperature T1 and temperature T2 may be prepared for separate reaction processes, to allow efficient production of silicon.

The obtained silicon is polycrystalline, and it has high purity suitable for use as a solar cell silicon material.

The method for producing silicon according to the invention may additionally include a step in which the silicon and metal halide obtained by the production method are separated.

If necessary, further treatment with an acid or alkali, directional solidification or dissolution under a high vacuum, may be carried out to remove the metal component residue adhering onto the obtained silicon and the unreacted metal components. Of these procedures, directional solidification can further reduce impurity elements in the silicon and increase the purity of the silicon.

Directional solidification is carried out, for example, by dissolving the silicon in a die and then releasing heat to accomplish solidification from the bottom while controlling the rate of solidification. Since the impurities eventually collect around the finally solidified sections, those sections may be cut out and removed to obtain high-purity silicon while also controlling the crystal structure. Several repetitions of directional solidification can yield even higher purity silicon.

The ingot obtained by the directional solidification is generally sliced by inside blade cutting or the like, and then the surface wrapped using a free abrasive and dipped into an etching solution of hydrofluoric acid or the like in order to remove the damage layer. This step yields a silicon wafer.

The conduction type of the wafer will generally be p-type. By adding boron or leaving aluminum as a dopant, it is possible to produce a wafer having p-type conductivity.

In order to reduce light reflective loss on the surface of the polycrystalline silicon wafer, a dicing machine, for example, may be used to mechanically form a V-groove. A textured structure may also be formed by reactive ion etching or isotropic etching using an acid. A diffusion layer of an n-type dopant such as phosphorus or arsenic is then formed on the receiving surface to form a p-n junction. After an oxide film layer of TiO₂ or the like has been formed on the surface, an electrode is attached to each side, and an antireflection film of MgF₂ or the like is formed to lower loss of light energy by reflection, thus completing the solar cell.

A preferred embodiment of the invention was explained above, but this disclosed embodiment of the invention is merely an example and is not intended to limit the scope of the invention in any way.

### EXAMPLES

The present invention will now be described in greater detail by examples, with the understanding that the invention is not limited thereto. The measurements were conducted under the following conditions.

### Silicon Content

A sample was collected, sodium hydroxide was added and the mixture was heated to melting for 2 hours in an electric furnace at 500° C. The melt was dissolved in purified water, hydrochloric acid was added to acidity, and after volume adjustment to a constant volume, the silicon and residual aluminum masses were measured by ICP-AES. The silicon content was determined from the obtained value using the following formula.

Silicon content (%)=([silicon mass]/[silicon mass+aluminum mass])×100

Yield

Yield (%)=([Silicon mass in sample collected after reaction]/[mass assuming complete replacement of aluminum used in reaction with silicon])×100

The mass assuming complete replacement of aluminum used in the reaction with silicon is, for example, 0.78 g for 1 g of aluminum.

### Oxygen Concentration

The oxygen concentration in the particles was measured by melting in a graphite crucible in an inert transported gas atmosphere and analyzing the CO or CO₂ gas generated by the reaction between oxygen and the crucible by an infrared absorbing method. A Model TC-600 by LECO was used as the measuring apparatus.

### Example 1

In order to accurately evaluate the reaction site temperature, the temperature relationship between each preset temperature of the tubular furnace and the area of placement of the metal was determined before the experiment. Each of the temperatures of the tubular furnace given below represent the temperature at the reaction site, and particularly the temperature of the metal.

After placing 18 g of aluminum particles (VA1520, product of Yamaishi Metal Co., Ltd., mean particle size: 125 μm) in a graphite container (interior dimensions: 90 mm length×60 mm width×25 mm height), the container was kept in a controlled-atmosphere tubular furnace (MS-1950, product of Motoyama Co., Ltd.) and the tube was exchanged with argon gas. The controlled-atmosphere tubular furnace was kept at 620° C. while feeding argon gas, and then argon gas was fed at 100 SCCM into the sample section for 1 hour through a gas cylinder filled with silicon tetrachloride (product of TriChemical Laboratories, Inc.) kept at 45° C. (first step). Next, the gas was switched to argon and the temperature was lowered to room temperature. The reaction product was loosened inside the beaker and analyzed, by which an increase of 32 mass % in the silicon content was confirmed. The same sample was placed in a 1 g alumina boat (SSA-S Boat #6A by Nikkato Corp.) and held in a tube furnace (Model KTF035N by Koyo Thermo System Co., Ltd.) for exchange of the furnace interior with argon gas. The tube furnace was kept at 820° C. while feeding argon gas, and then argon gas was fed at 60 SCCM into the sample section for 30 minutes through silicon tetrachloride kept at 45° C. (second step). Next, the gas was switched to argon and the temperature was lowered to room temperature. The reaction product was loosened inside the beaker and analyzed, by which an increase of 98 mass % in the silicon content was confirmed. The obtained silicon can be subjected to unidirectional solidification to further reduce impurity elements in the silicon.

### Comparative Example 1

Silicon production was attempted in the same manner as Example 1, except that the first step of reaction in the controlled-atmosphere tubular furnace at 620° C. for 1 hour was omitted. As a result, the reaction product included aluminum that had melted and solidified in the alumina boat. Almost no reduction reaction occurred as a result.

### Comparative Example 2

The first step of reaction in a controlled-atmosphere tubular furnace at 620° C. for 1 hour was repeated 5 times in the same manner as Example 1, loosening the obtained reaction product each time. The second step was omitted.

The silicon concentration of the obtained particles was 86 mass %.

### Example 2

After placing 20 g of aluminum particles (Hi-Al-150 μm, product of Yamaishi Metal Co., Ltd., mean particle size: 30 μm) in a graphite container, the container was kept in a controlled-atmosphere tubular furnace and the tube was exchanged with argon gas. The furnace interior was kept at 570° C. while feeding argon gas, and then argon gas was fed at 400 SCCM into the sample section for 30 minutes through a gas cylinder filled with silicon tetrachloride kept at 45° C. (first step). Next, the gas was switched to argon and the temperature was lowered to room temperature. The silicon content increased to 23 mass %. After then placing 1 g of the same sample in a graphite container and holding it in the furnace, keeping the furnace interior at 800° C., silicon tetrachloride was blown into the sample section for 5 minutes in the same manner as the first step (second step). Next, the gas was switched to argon and the temperature was lowered to room temperature. The silicon content increased to 98 mass %.

### Example 3

After holding 1 g of 23 mass % silicon-containing particles prepared in the first step of Example 2 at 600° C., silicon tetrachloride gas was blown in for 3 minutes (first step). The silicon content increased to 76 mass %. After then keeping 0.3 g of the same sample at 800° C. in the furnace, silicon tetrachloride was blown in for 3 minutes in the same manner as the first step (second step). The procedure was otherwise carried out as in Example 2. The silicon content increased to 96 mass %.

### Example 4

After holding 10 g of aluminum particles at 570° C., silicon tetrachloride was blown in for 73 minutes with the argon gas flow rate at 100 SCCM (first step). The silicon content was 48 mass %. After then keeping 6.5 g of the same sample at 770° C., silicon tetrachloride was blown into the sample section for 37 minutes in the same manner as the first step (second step). The procedure was otherwise carried out as in Example 2. The silicon content increased to 96 mass %.

### Example 5

After holding 0.5 g of aluminum particles prepared by centrifugal atomization (mean particle size: 60 μm) at 570° C., silicon tetrachloride was blown in for 5 minutes with the argon gas flow rate at 700 SCCM. The temperature was then raised to 590° C. and silicon tetrachloride was blown in for 10 minutes (first step). The silicon content was 12 mass %. After then holding 0.3 g of the same sample in the furnace and keeping the interior of the furnace at 820° C., silicon tetrachloride was blown in for 10 minutes in the same manner as the first step (second step). The procedure was otherwise carried out as in Example 2. The silicon content increased to 95 mass %.

### Example 6

The procedure was otherwise carried out as in Example 5, except that the treatment step at 590° C. during the first step was omitted. The silicon content was 3 mass % in the first step and 79 mass % in the second step.

### Example 7

After placing 1 g of aluminum particles (Hi-Al-150 μm product of Yamaishi Metal Co., Ltd.) in a graphite container, the container was kept in a tubular furnace and the tube was exchanged with argon gas. The furnace interior was kept at 570° C., and then argon gas was fed at 700 SCCM into the sample section for 15 minutes through a gas cylinder filled with silicon tetrachloride kept at 45° C. (first step). Next, the gas was switched to argon and the temperature was lowered to room temperature. The silicon content was confirmed to have increased to 26 mass %. After completing this first step, the furnace temperature was immediately raised to 820° C. and silicon tetrachloride was blown into the sample section for 15 minutes by the same procedure as the first step (second step). Next, the gas was switched to argon and the temperature was lowered to room temperature. The reaction product was immersed in hydrochloric acid for 1 minute of ultrasonic cleaning, and then the precipitate was taken out and the silicon content measured. The silicon content was 99.6 mass %, and the reaction product yield was 95 mass %.

### Example 8

The same procedure was carried out as in Example 7, except that the reaction temperature in the second step was 900° C. The silicon content was 99.4 mass %, and the reaction product yield was 95 mass %.

### Example 9

The same procedure was carried out as in Example 7, except that the reaction temperature in the second step was 950° C. The silicon content was 99.6 mass %, and the reaction product yield was 94 mass %.

### Example 10

The same procedure was carried out as in Example 7, except that the reaction temperature in the second step was 1000° C. The silicon content was 99.6 mass %, and the reaction product yield was 65 mass %.

### Example 11

The same procedure was carried out as in Example 7, except that the reaction temperature in the second step was 1050° C. The silicon content was 99.2 mass %, and the reaction product yield was 61 mass %.

### Example 12A

After placing 2 g of aluminum particles prepared by centrifugal atomization (mean particle size: 60 μm, oxygen concentration: 0.04 mass %) in a graphite container, it was placed in a furnace and the furnace interior was exchanged with argon gas (product of Japan Air Gases Co., purity: 99.9995 vol %). The oxygen concentration was monitored at the furnace outlet while feeding argon gas at 700 SCCM, and the oxygen concentration in the argon was found to be less than 1 ppm by unit volume. The furnace interior was kept at 450° C. under an argon flow, and then argon gas was fed into the sample section for 10 minutes through a gas cylinder filled with silicon tetrachloride kept at 45° C. (first step A). In order to measure the oxygen concentration of some of the obtained metallic particles by immobilizing the moisture on the surface as oxides, the silicon tetrachloride flow was blocked and the furnace interior was kept at 600° C. for 5 hours while feeding argon gas with that state maintained. After lowering the temperature to room temperature, the oxygen concentration of the aluminum particles was measured and found to be 0.06 mass %.

Next, the metallic particles without immobilization of moisture as oxides were further reacted, for reaction between the silicon tetrachloride and aluminum particles for 10 minutes each at temperatures of 570° C. (first step B), 600° C. (first step C) and 820° C. (second step). The silicon content of the reaction product was 99.7 mass %.

### Reference Example 12B

The furnace interior was kept at 400° C. and silicon tetrachloride gas was introduced into the furnace for 10 minutes (first step A). First step B, first step C and the second step were not carried out, but the oxygen concentration of the aluminum particles was measured upon completion of first step A in the same manner as Example 12A. The oxygen concentration of the aluminum particles was 0.08 mass %.

### Reference Example 12C

The furnace interior was kept at 550° C. and silicon tetrachloride gas was introduced into the furnace for 10 minutes (first step A). Otherwise, the oxygen concentration was measured in the same manner as Reference Example 12B. The oxygen concentration of the aluminum particles was 0.08 mass %.

### Reference Example 12D

The aluminum particles were held at 600° C. for 5 hours for immobilization of the moisture, without introducing silicon tetrachloride gas, i.e. without carrying out the first step of contacting the silicon tetrachloride and aluminum particles. Otherwise, the oxygen concentration was measured in the same manner as Reference Example 12B. The oxygen concentration of the aluminum particles was 0.17 mass %.

### Reference Example 12E

The furnace interior was kept at 300° C. and silicon tetrachloride gas was introduced into the furnace for 10 minutes (first step A). Otherwise, the oxygen concentration was measured in the same manner as Reference Example 12B. The oxygen concentration of the aluminum particles was 0.20 mass %.

### Reference Example 12F

The furnace interior was kept at 200° C. and silicon tetrachloride gas was introduced into the furnace for 10 minutes (first step A). Otherwise, the oxygen concentration was measured in the same manner as Reference Example 12B. The oxygen concentration of the aluminum particles was 0.26 mass %.

### Example 12G

Silicon tetrachloride and aluminum particles were reacted under the same conditions as Example 12A, with the omission of first step A of treating the aluminum particles with silicon tetrachloride at 450° C. The silicon content of the reaction product was 98.7 mass %.

### Example 13

After holding 2 g of aluminum particles (VA1520, product of Yamaishi Metal Co., Ltd., mean particle size: 125 μm, oxygen concentration: 0.11 mass %) at 450° C., they were reacted with silicon tetrachloride for 10 minutes with an argon gas flow rate of 100 SCCM (first step A). Also, the silicon tetrachloride and the aluminum particles were reacted at 540° C. for 30 minutes (first step B), at 640° C. for 10 minutes (first step C) and at 820° C. for 30 minutes (second step). The procedure was otherwise carried out as in Example 12A. The silicon content of the reaction product was 97.9 mass %.

The representative conditions and results for these examples and reference examples are shown in Tables 1 and 2.

TABLE 1

| | First step | | First step | | Second step | | |
|---|---|---|---|---|---|---|---|
| | temperature | Silicon | temperature | Silicon | temperature | Silicon | |
| | T1a | content | T1b | content | T2 | content | Yield |
| | [° C.] | [mass %] | [° C.] | [mass %] | [° C.] | [mass %] | [mass %] |
| Example 1 | 620 | 32 | — | — | 820 | 98 | — |
| Comp. Ex. 1 | — | — | — | — | 820 | 0 | — |
| Comp. Ex. 2 | 620° C., × 5 | 86 | — | — | — | — | — |
| Example 2 | 570 | 23 | — | | 800 | 98 | — |
| Example 3 | 570 | 23 | 600 | 76 | 800 | 96 | — |
| Example 4 | 570 | 48 | — | — | 770 | 96 | — |
| Example 5 | 570 | — | 590 | 12 | 820 | 95 | — |
| Example 6 | 570 | 3 | — | — | 820 | 79 | — |
| Example 7 | 570 | 26 | — | — | 820 | 99.6 | 95 |
| Example 8 | 570 | 26 | — | — | 900 | 99.4 | 95 |
| Example 9 | 570 | 26 | — | — | 950 | 99.6 | 94 |
| Example 10 | 570 | 26 | — | — | 1000 | 99.6 | 65 |
| Example 11 | 570 | 26 | — | — | 1050 | 99.2 | 61 |

TABLE 2

| | | | Oxygen | | | Second | |
|---|---|---|---|---|---|---|---|
| | Oxygen | First step | conc. of | First step | First step | step | |
| | conc. of | temperature | treated | temperature | temperature | temperature | Silicon |
| | Al particles | T1a | particles | T1b | T1c | T2 | content |
| | [mass %] | [° C.] | [mass %] | [° C.] | [° C.] | [° C.] | [mass %] |
| Example | 0.04 | 450 | 0.06 | 570 | 600 | 820 | 99.7 |
| 12A | | | | | | | |
| Ref. Ex. 12B | 0.04 | 400 | 0.08 | — | — | — | — |
| Ref. Ex. 12C | 0.04 | 550 | 0.08 | — | — | — | — |
| Ref. Ex. 12D | 0.04 | — | 0.17 | — | — | — | — |
| Ref. Ex. 12E | 0.04 | 300 | 0.20 | — | — | — | — |
| Ref. Ex. 12F | 0.04 | 200 | 0.26 | — | — | — | — |
| Example | 0.04 | — | — | 570 | 600 | 820 | 98.7 |
| 12G | | | | | | | |
| Example 13 | 0.11 | 450 | — | 540 | 640 | 820 | 97.9 |

### INDUSTRIAL APPLICABILITY

According to the invention there is provided a method for producing silicon at a high conversion.

1. A method for producing silicon wherein a halogenated silane represented by the following formula (1) is reduced with a metal, the method comprising:
a first step of bringing metal particles into contact with a halogenated silane at a temperature T1 below the melting point of the metal to obtain silicon; and
a second step following the first step, of bringing the metal residue into contact with a halogenated silane at a temperature T2 at or above the melting point of the metal to obtain additional silicon;
SiHₙX₄₋ₙ (1)
wherein n represents an integer of 0-3 and X represents an atom selected from the group consisting of F, Cl, Br and I; and
wherein when n is 0-2, each X may be the same or different from one another.

2. The method for producing silicon according to claim 1, wherein the proportion of the silicon mass with respect to the total mass of the metal residue and the obtained silicon is 5 mass % or greater and less than 85 mass % upon completion of the first step.

3. The method for producing silicon according to claim 1, wherein the first step and second step are carried out in a fixed bed reactor.

4. The method for producing silicon according to claim 1, wherein the first step and second step are carried out in a rotary kiln or a fluidized bed reactor.

5. The method for producing silicon according to claim 1, wherein the metal includes one or more selected from the group consisting of potassium, cesium, rubidium, strontium, lithium, sodium, magnesium, aluminum, zinc and manganese.

6. The method for producing silicon according to claim 1, wherein the metal is aluminum.

7. The method for producing silicon according to claim 1, wherein the halogenated silane includes one or more selected from the group consisting of silicon tetrachloride, trichlorosilane, dichlorosilane and monochlorosilane.

8. The method for producing silicon according to claim 1, wherein the boron and phosphorus contents of the halogenated silane are each less than 1 ppm, and the boron and phosphorus contents in the metal silicon are each less than 1 ppm.

9. The method for producing silicon according to claim 1, wherein the temperature T1 in the first step is at least 0.6 times the melting point [° C.] of the metal, and below the melting point of the metal.

10. The method for producing silicon according to claim 1, wherein the first step comprises bringing the metal particles into contact with the halogenated silane at temperature T1a which is at least 0.6 times the melting point [° C.] of the metal and below the melting point of the metal, and thereafter further bringing the metal particles into contact with the halogenated silane at temperature T1b which is above temperature T1a and below the melting point of the metal.

11. The method for producing silicon according to claim 1, wherein the first step comprises bringing the metal particles into contact with the halogenated silane at temperature T1a which is at least 0.6 times the melting point [° C.] of the metal and below the melting point of the metal to lower the oxygen concentration of the metal to less than 0.1 mass %, and further bringing the metal particles into contact with the halogenated silane at temperature T1b which is above temperature T1a and below the melting point of the metal.

12. The method for producing silicon according to claim 1, wherein a temperature T2 in the second step is at least 1.2 times the melting point [° C.] of the metal, and below 0.8 times the melting point [° C.] of silicon.
